(19) United States
(12) Patent Application Publication
(10) Pub. No.: US 2011/0124288 A1
(43) Pub. Date: May 26, 2011

(54) APPARATUS AND METHOD FOR AUTOMATIC WIRELESS LINK REPLACEMENT

(75) Inventors: Yi-Hung CHEN, Hsinchu County (TW); Chwan-Chia WU, Taipei City (TW)

(73) Assignee: GRANDEX INTERNATIONAL CORPORATION, Taipei (TW)

(21) Appl. No.: 12/835,290

(22) Filed: Jul. 13, 2010

(30) Foreign Application Priority Data
Nov. 24, 2009 (TW) 098139929

(51) Int. Cl. H04B 7/00

(52) U.S. Cl. 455/42

(57) ABSTRACT

An apparatus and a method for automatically establishing a new wireless link, when the original wireless link between the apparatus and a commercially available FM radio receiver is interfered by other signal sources, thereby eliminating the need to manually configure both the target FM radio receiver and the apparatus to a suitable FM frequency. The apparatus modulates an audio signal on a selected frequency and transmits the resulting FM signal to the target FM radio receiver, scans an FM spectrum for available frequencies, selects one of the available frequencies as an alternate frequency, transmits a Radio Data System compatible command incorporating the alternate frequency to configure the target FM radio receiver to tune to the alternate frequency when reception conditions are poor.

This application claims the benefit of the Taiwan Patent Application Serial NO. 098139929, filed on Nov. 24, 2009, the subject matter of which is incorporated herein by reference.

### BACKGROUND OF THE INVENTION

### 1. Field of the Invention

The present invention relates to the field of automatic establishment of a wireless link from an audio output device to a Radio Data System (RDS) compatible FM receiver, and more particularly relates to an apparatus and a method for providing the capability to automatically establishing a new wireless link when the original wireless link is subjected to interference.

With the advance of digital technology, many consumer electronic devices such as MP3 players, PDAs (Personal Digital Assistants), portable multimedia players, mobile communication devices and MIDs (mobile Internet devices), are used as portable audio devices for playing music at any time and any place.

One can use either a headphone unit or an FM radio receiver to listen to the audio (i.e., music, etc.) played by a portable audio device. When using an FM radio receiver to receive audio content played by an audio device, the audio signal originated from the audio device can be transferred to the FM radio receiver by either a wire connection or a wireless connection. When connection is via a wireless link, the audio device normally uses an FM transmitter to modulate the audio signal on an FM carrier signal and transmits this FM modulated audio signal to an FM radio receiver located relatively close by. The FM carrier is set to a particular carrier frequency that is selected from one or more available frequencies. The FM transmitter used here can be a functional unit built in the audio device, or a stand-alone unit that is connected to the audio output port of the audio device. A typical application is using an FM transmitter to convert the audio signal generated by a portable audio device to an FM signal and further transmit the FM signal over an available FM frequency, when driving a car, one can then listen to the desired audio through a car's built-in FM radio receiver as long as the FM radio receiver is tune to the frequency on which the FM signal is transmitted.

The same method can be applied to reception of audio programs broadcasted by a digital audio broadcast system. There are several digital audio broadcast systems available nowadays, which include terrestrial digital broadcasting systems such as DAB (Digital Audio Broadcasting), DRM (Digital Radio Mondiale), DMB (Digital Multimedia Broadcast), IBOC (In-Band On-Channel) system, etc., and satellite-based digital radio systems such as XM Satellite Radio, Sirius Satellite Radio, WorldSpace Europe, etc. In order to be able to receive audio programs broadcasted by digital audio broadcasters in car, one needs to replace the existing analog in-car FM stereo system by a new audio system that is capable of receiving digital audio broadcast programs. Doubtlessly, this is wasteful and costly if the existing in-car audio system is a sophisticated and high quality system. Alternatively, one can install a less expensive digital radio receiver of which the main function is to receive audio programs from digital audio broadcasters. One can then apply an FM transmitter to convert the audio signal generated by the digital radio receiver to an FM modulated audio signal and then transmit this FM signal to an in-car FM radio receiver on an available FM frequency. By doing so, one can receive and listen to a desired digital audio broadcast station through the car's built-in sound system by tuning the in-car FM radio receiver to the frequency on which the desired modulated audio signal is transmitted.

As described above, if one wants to use an FM transmitter to transmit an audio signal to a nearby FM radio receiver, one needs to select an available frequency as the carrier frequency for transmission. In general, this requires back and forth operations to find an available frequency that is suitable for transmission. For example, one needs to manually search for an available frequency through a target FM radio receiver, once an available frequency is found, tune the FM transmitter manually to this selected available frequency and then broadcast the desired audio signal via this available frequency.

However, the aforementioned operation becomes unpractical when driving a car across a metropolitan area where FM spectrum is crowded or driving on a long distance journey. This is because that a frequency available in one area may no long be available in another area. In this case, the available frequency selected by the FM transmitter for transmission has to be changed to avoid interference by other FM stations. Thereby a car driver may need to perform the above-mentioned operations again and again whenever the received signal is corrupted. Obviously, this is very inconvenient and may jeopardize safety when driving a car.

In view of this, many proposals have been developed for solving such problems. For example, U.S. Pat. No. 6,493,546 discloses an automatic scanning method for finding available channels and in the mean time monitoring the signal quality of the current transmission channel, and then providing as an advice for the user to tune the FM radio receiver to a new available channel selected for transmission.

The ROC (Republic of China) patent I261420 discloses a method for applying to a DAB adapter, which uses the FM receiving means of the DAB adapter to automatically search for available frequencies over a specific spectrum. The user can then base on the search result to select one of the available frequencies for transmission.

Although the preceding patents propose methods for automatically scanning available channels for transmission, it is still required to manually tune the target FM radio receiver to an available channel in order to establish a wireless link between the FM transmitter and the target FM radio receiver.

US patent application number US2009/0111389 A1 discloses a system and a method for automatically scanning the FM spectrum to find available frequencies, determining when to select one of the available frequencies for transmission, and communicating a signal to the other device to cause that device change to the selected available frequency. The proposed system comprises an FM transmitter and an FM receiver, wherein the FM receiver is used to scan FM spectrum for finding available frequencies. The FM transmitter and the FM receiver are enabled interchangeably, namely, the FM transmitter and the FM receiver cannot be enabled at the same time. The FM receiver is enabled to perform frequency scanning during the periods of silence of the audio input signal. Although the aforementioned document proposes a system and a method for providing a mechanism that does not require user intervention to achieve uninterrupted listening to the audio content originated from a portable audio device via car speakers, in some circumstances, it may not be able to switch to a quiet channel successfully. This is because when driving a car across a metropolitan area, where the FM spectrum is crowded, it may require to change transmission frequency frequently to avoid signal corruption by interference, and further it may take longer time to find an available frequency. As a result, a required frequency change may not take place at the desired time due to insufficient time (of silence) for finding an available frequency. In this case, listeners in the car may suffer interference or even worse loss of the audio program to which they are currently listening to.

It is therefore desirable to have a mechanism whereby a wireless link between an FM transmitter and a car's radio or target FM radio receiver is replaced automatically without the need for the user to search for an available frequency and manually tune the target FM radio receiver to the selected available frequency. It is further desirable that the transition of the wireless link from one frequency to the other is smooth and instant to avoid hearing signal interference from the car's speaker(s).

### SUMMARY OF THE INVENTION

To overcome limitations in the prior art described above, and to overcome other limitations that will become apparent upon reading and understanding the description herein of the present invention, the present invention discloses a signal converting apparatus and method for automatically establishing a new wireless link between the apparatus and a commercially available FM radio receiver when the original link is interfered by other signal sources.

The object of the present invention is to provide a novel apparatus and method for automatically establishing a new wireless link between an audio signal source and a commercially available FM radio receiver. Use of the present method eliminates the need to manually configure both the FM transmitter and the target FM radio receiver to a quiet (or an available) FM channel. The apparatus of the present invention continuously monitors an existing wireless link between the FM transmitter and the target FM radio receiver, and when the current wireless link is interfered by other signal sources, establishes a new clear wireless link automatically without manual intervention by the user. The apparatus and present method achieves low latency for link setup and provides instant change-over to a new wireless link. As the invention can provide uninterrupted listening to the desired audio content without user intervention, it is therefore especially applicable to listening to audio content originated from an audio device through car's sound system.

To ensure clear and high quality play back of the desired audio signal generated by an external audio device through the target FM radio receiver, the wireless link has to be established over a quiet channel that is not used by any signal source such as an FM station. The object of this invention is to provide a mechanism to scan the FM spectrum automatically and find one or more available frequencies that are suitable for use for transmission (i.e., for establishing a wireless link). Further, the present invention provides a mechanism to continuously monitor the current channel in use for wireless link and provides a method to determine when to establish a new link. When establishment of a new wireless link is required, the mechanism signals the target FM radio receiver with a command that causes the target FM radio receiver to tune to the frequency selected for the new link.

There is thus provided in accordance with the present invention a method of establishing a wireless link between a target FM radio receiver and an apparatus having an FM transmitter and an FM receiver. The method includes the steps of scanning the FM spectrum for one or more available frequencies; selecting one of the available frequencies as an alternate frequency for the FM transmitter and the target FM radio receiver; sending a command incorporating the selected alternate frequency from the FM transmitter to the target FM radio receiver over the frequency that the target FM radio receiver is currently tune to (and also the frequency which the FM transmitter is currently used for transmission); monitoring signal quality of the frequency that the FM transmitter is currently used for transmission; and when the signal quality is poor changing the transmission frequency of the FM transmitter to the alternate frequency to cause the target FM radio receiver to switch to the alternate frequency.

There is further provided in accordance with the present invention an apparatus including an FM transmitter, an FM receiver, a processor coupled to the FM transmitter and the FM receiver. The processor is operable to configure the FM receiver to scan the FM spectrum for one of more available frequencies and to monitor the signal quality of the frequency that the FM transmitter is currently used for transmission, select one of the available frequencies as an alternate frequency for the FM transmitter and the target FM radio receiver, generate and send a command incorporating the alternate frequency from the FM transmitter to the target FM radio receiver over the frequency that the target FM radio receiver is currently tune to, determines when to select the alternate frequency as the transmission frequency to cause the target FM radio receiver to switch to the alternate frequency.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a diagram illustrating the system and a signal converting apparatus of the present invention for establishing a wireless link between an FM radio receiver and the apparatus;

FIG. 2 shows an exemplary embodiment of an apparatus of the present invention;

FIG. 3 shows other exemplary embodiment of the apparatus of the present invention;

FIG. 4 shows another exemplary embodiment of the apparatus of the present invention; and

FIG. 5 shows a block diagram illustrating the steps in the method of the present invention for establishing a wireless link between an FM radio receiver and the present apparatus.

### DETAILED DESCRIPTION OF THE PREFERRED EMBODIMENTS

The present invention provides an apparatus and method for automatically establishing a new wireless link between the apparatus and a commercially available FM radio receiver. Use of the invention eliminates the need to manually configure both the apparatus and the target FM radio receiver to an available FM channel. The apparatus of the present invention continuously monitors an existing wireless link between the apparatus and the target FM radio receiver, and when the current wireless link is interfered by other signal sources, automatically establishes a new clear wireless link without manual intervention by the user. The invention achieves low latency for link setup and provides instant switch to the new wireless link.

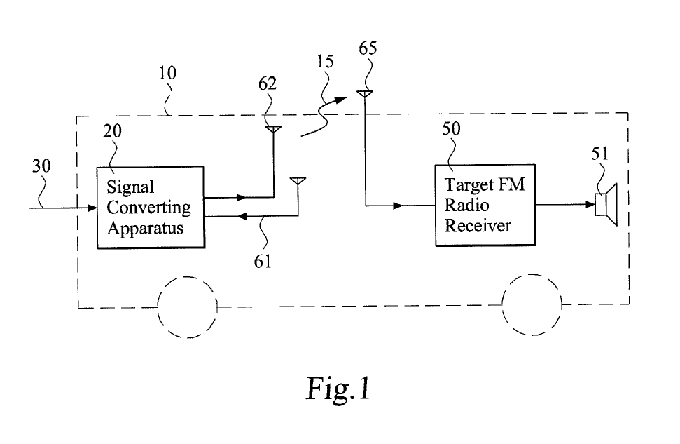

A system block diagram illustrating a wireless link established between an FM radio receiver and an apparatus of the present invention, both are installed in a vehicle, is shown in FIG. 1. The system 10 includes a signal converting apparatus 20, a target FM radio receiver 50 and speaker(s) 51. In one general aspect, an audio input signal 30 originated from an external audio device (not shown in the drawing) is sent to the apparatus 20 where the audio input signal 30 is modulated to an FM signal 15. The resulting FM signal 15 is further transmitted over a selected frequency (denoted as current frequency throughout this document) through an antenna 62. The FM signal 15 is received by the target FM radio receiver 50 via an antenna 65. The target FM radio receiver 50 demodulates the received FM signal 15 and sends the resulting demodulated signal to the car speaker(s) 51 from which the audio input signal 30 is reproduced. The FM signal 15 is thereby considered as a wireless link between the apparatus 20 and the target FM radio receiver 50 as long as the target FM radio receiver 50 tunes to the current frequency transmitted by the apparatus 20.

In one exemplary embodiment of the present invention, the target FM radio receiver 50 is compatible with the Radio Data System (RDS) [or the Radio Broadcast Data System (RBDS), the official name used for the United States version of RDS], meaning that the target FM radio receiver 50 is configured to receive and understand the received RDS bitstream. The apparatus 20 may further includes an antenna 61 to receive a plurality of signals for scanning an FM spectrum for finding available frequencies, and for monitoring the signal quality of the wireless link 15.

The audio input signal 30 is originated from an external audio device. Examples of external audio devices include personal digital assistants (PDAs), cellular phones, mobile Internet devices (MIDs), digital audio radio receivers, portable music players, and the like, wherein digital audio radio receivers include terrestrial digital broadcast radio receivers, satellite digital radio receivers; and portable music players include CD players, MP3 players, iPod®, portable multimedia players, and so forth.

To ensure clear reception by the target FM radio receiver 50 of the audio signal sent from the apparatus 20, the frequency selected for transmission and used for establishing the wireless link 15 needs to be an available frequency that is not used by any FM station for broadcast. However, a particular frequency available for transmission in one geographic area may become unavailable in another geographic area, where there is an FM station broadcasting either on this particular frequency or on a nearby frequency. Therefore, the frequency used for transmission of a signal from the apparatus 20 to the target FM radio receiver 50 needs to be changed when the system 10 is moving toward a geographic area, where the current transmission is interfered by other signal sources.

The present invention thereby provides a mechanism to establish a new and clear wireless link between the apparatus 20 and the target FM radio receiver 50 when the present wireless link is interfered.

In one exemplary embodiment of the present invention, the mechanism is operable to continuously monitor the spectrum status of the FM spectrum by the apparatus 20. The apparatus 20 scans the FM spectrum continuously or periodically for finding available frequencies, selects one of the available frequencies as an alternate frequency, examines the signal quality of the present wireless link, and when poor signal quality is determined transmits the desired audio signal over the selected alternate frequency to the target FM radio receiver 50.

The mechanism makes use of the RDS standard. The mechanism generates and sends an RDS message over the current frequency to the target FM radio receiver 50. The RDS message comprises at least an AF command including the selected alternate frequency and a Program Identification (PI) code. One application of this PI code would be to enable the receiver to search automatically for an alternate frequency included in the AF command in case of poor reception of the program to which the receiver is tuned; the switch-over to the new frequency would take place if a clear signal present on that frequency having the same PI code. Therefore, this AF command causes the target FM radio receiver 50 to jump to the alternate frequency when reception conditions deteriorate sufficiently so that the target FM radio receiver 50 can continuously receive the FM signal 15 sent by the apparatus 20.

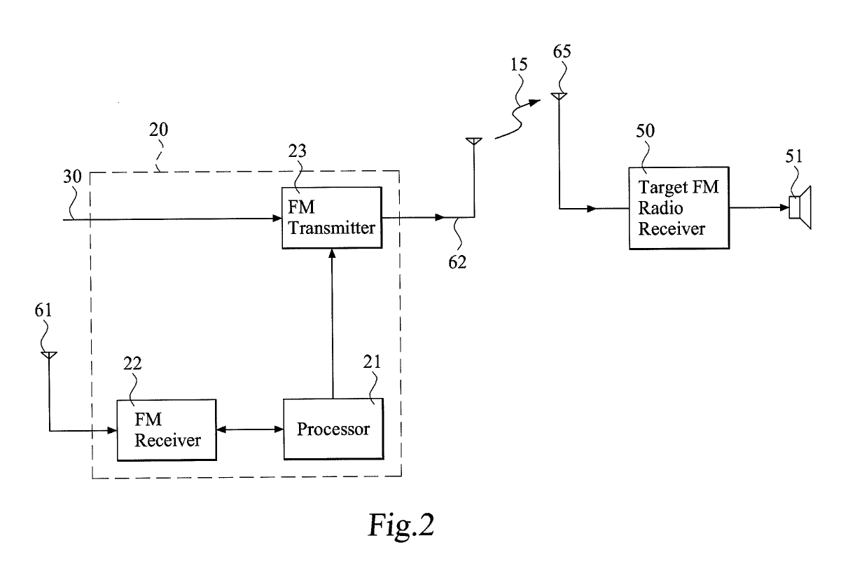

In accordance with one exemplary embodiment of the present invention, the apparatus 20, as illustrated in FIG. 2, includes a processor 21, an FM receiver 22, an FM transmitter 23, an antenna 61 for receiving signals, and an antenna 62 for transmitting signals.

The FM receiver 22 is connected to an antenna 61 and is configured in such a manner to be operable to scan the FM spectrum for finding available frequencies. The FM receiver 22 may go through each potential frequency and determine whether a signal is present on that particular frequency by measuring the signal strength (for example, received signal strength indication (RSSI)). If the signal strength such as RSSI of a particular frequency exceeds a predetermined threshold value, it can be considered that a signal is present on that particular frequency. A particular frequency may be considered available if the signal strength (RSSI) is equal to or less than the predetermined threshold value.

The FM receiver 22 is also operable to determine the signal quality of a signal over a particular frequency. The signal quality of a desired signal degrades if there are one or more other signal sources present on the same or close to the particular frequency on which the desired signal is present. The signal quality of a particular frequency may be analyzed by measuring a signal strength (RSSI) or a signal-to-noise ratio (SNR) of the received signal. For example, the desired signal may be considered interfered by other sources if the SNR reading is below a predetermined threshold value.

The FM transmitter 23 is configured in such a manner to be operable to receive and modulate an audio input signal 30, the resulting signal 15 is transmitted over the current frequency to the target FM radio receiver 50 via the antenna 62.

The processor 21 is connected to the FM receiver 22 and the FM transmitter 23, and is operable to configure the FM receiver 22 to continuously monitor an FM spectrum to identify available frequencies. The processor 21 may automatically select one of the available frequencies as the alternate frequency for transmission. The processor 21 is further operable to cause the FM transmitter 23 to generate and send a signal incorporating the selected alternate frequency to the target FM radio receiver 50 over the current frequency. To ensure that transmission is performed through a quiet channel, the processor 21 is also operable to configure the FM receiver 22 to continuously monitor the current frequency to examine whether the desired signal is interfered. When interference on the desired signal is determined, the processor 21 may cause the FM transmitter 23 to change frequency and send the FM signal over the alternate frequency. Thus the apparatus 20 automatically determines when to change the frequency over which the FM signal 15 is transmitted, and when such a change is required both of the FM transmitter 23 and the target FM radio receiver 50 are configured to switch to the selected alternate frequency for transmission and reception, respectively.

As described above, a frequency may be considered available if the signal strength such as RSSI is equal to or less than a certain threshold value. But the signal strength of this frequency may increase gradually and exceed the threshold value some time later if the vehicle is moving toward a geographic area, where an FM station located in this area broadcasts over this frequency or a nearby frequency. In this case, if this particular frequency is selected as the alternate frequency and used for transmission, the apparatus 20 may need to change the frequency for transmission again in a short time due to signal corruption by interference. To reduce the possibility of frequent change of the frequency for transmission, there is further provided in accordance with the present invention a method comprising the steps of: performing analysis on each available frequency; selecting candidate frequencies from available frequencies; selecting one of the candidate frequencies as an alternate frequency. An available frequency is selected as a candidate frequency if the readings of the signal strength do not increase gradually over an observation period prior to the time of analysis.

To provide uninterrupted receiving and listening to the desired audio signal, the aforementioned processes for scanning available frequencies and monitoring signal quality are arranged to be performed simultaneously with signal transmission so that frequency change can be performed instantly when the transmitted signal is interfered. The processor 21 may thereby be arranged and configured to enable the FM receiver 22 and FM transmitter 23 at the same time so that the FM receiver 22 may receive signal via the antenna 61 while the FM transmitter 23 is transmitting a signal through the antenna 62.

In accordance with one exemplary embodiment of the invention, the apparatus 20 may be arranged and configured to operate as a standalone device as shown in FIG. 2. The apparatus 20 may be connected to an audio output device (not shown in the diagram) from which an audio signal 30 is generated and sent to the apparatus 20.

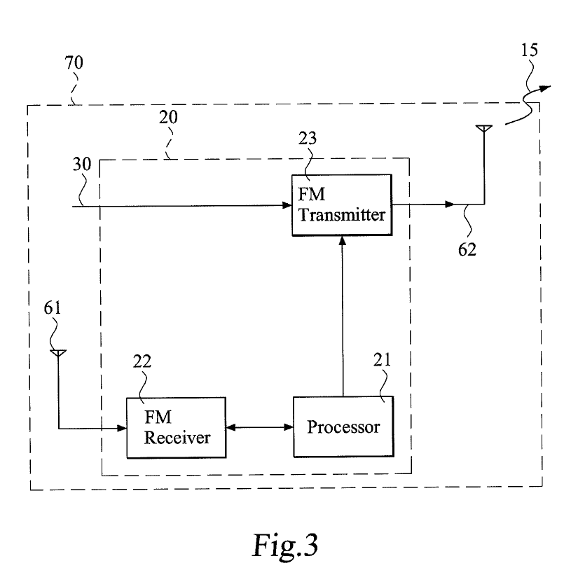

In other exemplary embodiment of the invention, the apparatus 20 may be integrated into or otherwise be made a part of a portable device 70 as shown in FIG. 3. As an example, the portable device 70 may include a multimedia player (such as MP3 player, iPod®, CD player or any other audio and/or video player), a personal digital assistant (PDA), a cellular phone, a mobile Internet device (MID), and/or a device that includes any combination of these types of devices.

Referring to FIG. 1, the audio signal 30 may be originated from a satellite broadcast signal or a terrestrial digital broadcast signal, it is therefore desirable to have a digital radio receiving device that includes an apparatus 20 and a terrestrial digital audio/video broadcast receiver and/or a satellite digital radio receiver for receiving digital broadcast signal, converting the received audio signal to an FM signal and further sending the resulting FM signal to the target FM radio receiver 50 and finally reproducing the audio signal via the speaker(s) 51.

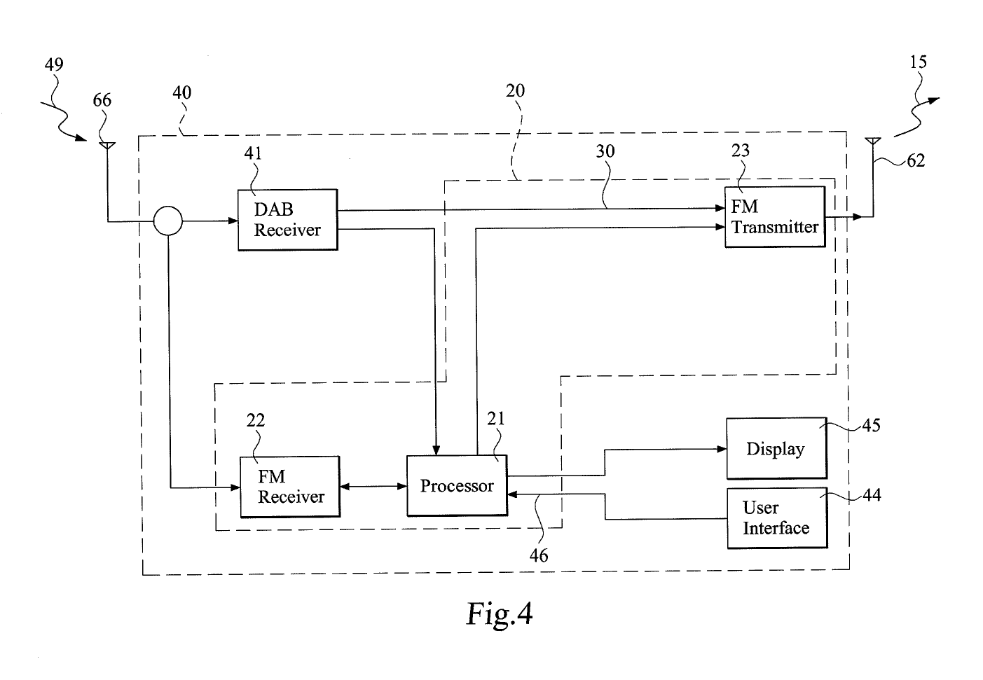

To this end, another exemplary embodiment of the present invention will now be described in detail with reference to FIG. 4. As shown in FIG. 4, a digital radio receiving device 40 includes a digital audio broadcasting (DAB) receiver 41, a user interface 44, a display 45, an apparatus 20 and an antenna 66. Referring to FIG. 2, the apparatus 20 further includes a processor 21, an FM receiver 22, an FM transmitter 23 and an antenna 62.

The DAB receiver 41 is connected to the processor 21 and the antenna 66, and is operable to receive and convert a selected DAB signal 49 to an audio signal 30. The user interface 44 is connected to the processor 21 for selecting a desired DAB station and performing other system settings and/or controls to the digital radio receiving device 40. The resulting control signal 46 is sent to the processor 21 for performing corresponding operations in response to the user's requests. The display 45 is connected to the processor 21 for displaying messages provided by the processor 21.

In one exemplary embodiment of the invention, the antenna 66 is also connected to the FM receiver 22 for receiving a plurality of FM signals. The antenna 66 is thereby a multi-band antenna that is at least applicable to FM band (87.5 MHz˜108 MHz) and Band III (174 MHz˜240 MHz) reception.

The processor 21 is configured to control the DAB receiver 41 based on the control signals 46 sending out from the user interface 44. The DAB receiver 41 performs the specific operations requested by the processor 21 and responds messages that may include DAB station name and other related information, such as radiotext Dynamic Label Segment (DLS), etc., to the processor 21. The processor 21 further shows the messages on the display 45.

The digital radio receiving device 40 may include a DAB receiver 41 as shown in FIG. 4. The digital radio receiving device 40 may also include a receiver of other types of digital broadcast systems for receiving audio signals of that particular digital broadcast system. Examples of the digital broadcast systems include terrestrial digital broadcasting systems such as Digital Radio Mondiale (DRM), Digital Multimedia Broadcast (DMB), In-Band-On-Channel (IBOC) systems, etc., and satellite-based digital radio systems such as XM Satellite Radio, Sirius Satellite Radio, WorldSpace Europe, etc.

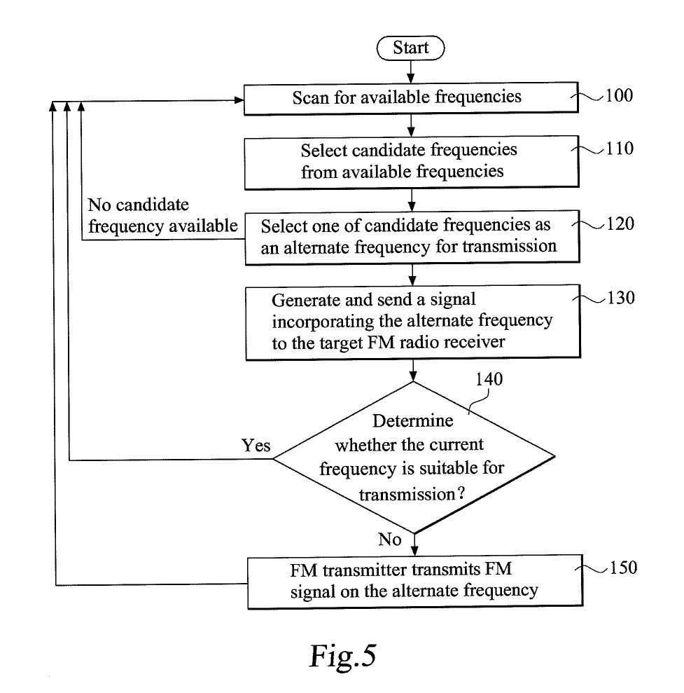

A flow diagram illustrating an automatic wireless link replacement method of the present invention is shown in FIG. 5. This method is provided to be implemented in the apparatus 20. It can be implemented in software/firmware for execution by a suitable processor, in hardware for execution by appropriate circuitry or a combination of both software/firmware and hardware. The method includes the steps of:

Step 100: scanning for available frequencies;

Step 110: selecting candidate frequencies from available frequencies;

Step 120: selecting one of candidate frequencies as an alternate frequency for transmission;

Step 130: generating and sending a signal incorporating the alternate frequency to the target FM radio receiver;

Step 140: determining whether the current frequency is suitable for transmission; and

Step 150: transmitting FM signal on the alternate frequency.

Initially, when a wireless link is established (over the current frequency), the FM receiver 22 first scans the FM spectrum for all available frequencies (step 100). The available frequencies should be sufficiently quiet to permit the reception of the FM transmitter signal. A frequency may be considered available if the reading of the signal strength (such as received signal strength indication (RSSI)) of this frequency is equal to or below a predetermined threshold value.

As described above, though an available frequency should be sufficiently quiet to permit the reception of a signal sent by the transmitter, it is only true at the time of scanning and may not be a right choice for transmission of the desired signal later on. This is because the system in a vehicle may be moving toward a geographic area, where an FM station broadcasts over this frequency or a nearby frequency, and therefore the signal strength of this frequency may increase gradually and may eventually exceed the threshold value for determining suitability of a frequency for transmission. In this case, when replacement of the current frequency for transmission is required, this particular frequency may not be available or be available only for a short time.

To avoid the possible situation described above, the available frequencies are further analyzed for selecting candidate frequencies (step 110). A candidate frequency is an available frequency, whose signal strength readings do not increase gradually over a certain observation period prior to the time of frequency scanning. One of the candidate frequencies is then selected as the alternate frequency (step 120). If no such candidate frequency can be found, and thereby no alternate frequency can be selected, the procedures stated above (step 100 and step 110) are performed repeatedly until an alternate frequency is selected.

An RDS message including an AF command is then generated and transmitted (step 130). The RDS message includes an AF command including the selected alternate frequency and a Program Identification (PI) code. The FM transmitter modulates this message on the frequency that is currently selected for signal transmission. The target FM radio receiver receives this RDS bitstream, decodes it and marks the received data as the alternate frequency for the frequency that the target FM radio receiver is currently tuned to. The target FM radio receiver will jump to the alternate frequency when reception conditions deteriorate sufficiently.

Next, the signal on the frequency currently selected for transmission is examined to determine whether this frequency is suitable for transmission of the desired signal (step 140). In one exemplary embodiment of the invention, the FM receiver is configured to be tuned to the frequency on which the FM transmitter is currently transmitting a signal. The signal quality of this frequency may be analyzed by measuring the signal-to-noise ratio (SNR) of the received signal. If the measured SNR is below a predetermined threshold value, the received signal may be interfered by other signal sources and the current frequency is considered not suitable for transmission of the desired signal, in this case, change of transmission frequency is required to ensure good reception by the target FM radio receiver. If the SNR reading equals to or exceeds the predetermined threshold value, the current frequency is considered suitable for transmission, in this case, the procedures described above (step 100 to step 140) are repeated until the current frequency is determined not suitable for transmission of the desired signal.

When change of transmission frequency is required, the FM transmitter modulates the desired audio signal and the RDS message described above on the selected alternate frequency (step 150). This causes the target FM radio receiver to switch frequency from the currently tuned frequency to the alternate frequency. The interfered wireless link is therefore automatically replaced by a clear wireless link without user intervention.

While the apparatus has been described in terms of its component circuits, it should be noted that any or all of these circuits may be implemented in software or hardware or any combination thereof, including but not limited to Application Specific Integrated Circuits (ASICs) or Field Programmable Gate Arrays (FPGAs) or any equivalent technology.

The steps in the method described above may be constructed as software objects that are executed in embedded devices as firmware, software objects are executable as part of a software application on either an embedded or non-embedded computer system such as a digital signal processor (DSP), reduced instruction set computing (RISC) processor, microcomputer, microprocessor, etc., or as software core realized HDL circuits embodied in an Application Specific Integrated Circuits (ASICs) or Field Programmable Gate Arrays (FPGAs) or as functionally equivalent discrete hardware components.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for automatic replacement of a wireless link between a target FM radio receiver and a signal converting apparatus when said wireless link is interfered by one or more signal sources, said apparatus including an FM transmitter and an FM receiver, said FM transmitter sending a transmission to the target FM radio receiver over a current frequency, said method comprising the steps of:
scanning an FM spectrum for available frequencies;
selecting one of said available frequencies as an alternate frequency for said current frequency;
generating and sending a signal incorporating said alternate frequency from said FM transmitter to said target FM radio receiver over the current frequency, wherein said signal includes a command to cause said target FM radio receiver to change to said alternate frequency;
measuring a signal quality of said current frequency for determining whether said current frequency is suitable for transmission of a signal; and
sending said transmission from said FM transmitter to said target FM radio receiver over said alternate frequency when said current frequency is determined not suitable for transmission.

2. The method of claim 1, wherein said step of scanning said FM spectrum comprises the step of configuring said FM receiver to scan through said FM spectrum measuring a signal strength of a received signal.

3. The method of claim 1, wherein said step of selecting said alternate frequency from said available frequencies further comprises the steps of analyzing a plurality of signal strength readings of each of said available frequency, said plurality of signal strength readings being measured in an observation period; selecting one or more available frequencies from said available frequencies as one or more candidate frequencies if said plurality of signal strength readings of said one or more available frequencies do not increase gradually; selecting one of said candidate frequencies as said alternate frequency for said current frequency.

4. The method of claim 1, wherein said step of measuring signal quality of said current frequency further comprises the steps of configuring said FM receiver to tune to said current frequency and measure a signal quality of a received signal on said current frequency; determining said current frequency not suitable for transmission of a signal if said signal quality goes below a predetermined threshold signal quality.

5. The method of claim 1, wherein said transmission is generated by the step of FM modulating an audio signal and modulating said signal incorporating said alternate frequency on a selected frequency.

6. The method of claim 1, wherein said signal incorporating said alternate frequency and said target FM radio receiver are compatible with the Radio Data System (RDS).

7. An apparatus for receiving an audio signal, modulating an audio signal to an FM signal, and sending said FM signal to a target FM radio receiver over a current frequency, said apparatus comprising:
an FM receiver operable to scan an FM spectrum for available frequencies, and to measure a signal quality of a particular frequency;
an FM transmitter operable to send a transmission to said target FM radio receiver over said current frequency, said transmission including said FM signal and one or more RDS messages;
a first antenna connected to said FM receiver and operable to receive at least one radio signal, the frequencies receivable by said first antenna at least including a spectrum from 87.5 MHz to 108 MHz;
a second antenna connected to said FM transmitter and operable to radiate said transmission sent by said FM transmitter into the air, the frequencies radiated by said second antenna at least including frequencies from 87.5 MHz to 108 MHz; and
a processor connected to said FM receiver and said FM transmitter.

8. The apparatus of claim 7, wherein said processor is operable to:
configure said FM receiver to substantially continuously monitoring an FM spectrum to identify available frequencies;
select one of said available frequencies as an alternate frequency for transmission;
generate and send said one or more RDS messages incorporating said alternate frequency from said FM transmitter to said target FM radio receiver over said current frequency;
configure said FM receiver to continuously monitoring said current frequency to determine whether said current frequency is suitable for transmission of said FM signal; and
configure said FM transmitter to send said transmission over said alternate frequency when said current frequency is not suitable for transmission.

9. The apparatus of claim 7, wherein said one or more RDS messages sent by said FM transmitter include a command, said command further comprising an information corresponding to said alternate frequency and a Program Identification (PI) code corresponding to said FM signal to cause said target FM radio receiver to tune to said alternate frequency when said FM signal on said current frequency is corrupted.

10. The apparatus of claim 7, wherein said FM receiver and said FM transmitter are configured to be enabled at the same time and operable simultaneously.

11. The apparatus of claim 7, wherein said transmission sent by said FM transmitter and said target FM radio receiver are compatible with the Radio Data System (RDS).
